(19) United States
(12) Patent Application Publication
(10) Pub. No.: US 2026/0177125 A1
(43) Pub. Date: Jun. 25, 2026

(54) HOROLOGY COMPONENT COLOURED BY INTERFERENCE EFFECT

(71) Applicant: Nivarox-FAR S.A., Le Locle (CH)

(72) Inventors: Julien BAILAT, Bienne (CH); Pierre CUSIN, Villars-Burquin (CH)

(73) Assignee: Nivarox-FAR S.A., Le Locle (CH)

(21) Appl. No.: 19/380,376

(22) Filed: Nov. 5, 2025

(30) Foreign Application Priority Data
Dec. 19, 2024 (EP) 24221464.1

(51) Int. Cl. F16F 1/02; F16F 1/10; G04B 17/32

(52) U.S. Cl. CPC F16F 1/024; F16F 1/021; F16F 1/10; G04B 17/32; F16F 2228/007

(57) ABSTRACT

A horology component including a substrate (2), a first interference layer (4) in contact with the substrate (2) and a second interference layer (3) covering the first interference layer (4). The interference layer (4) has a thickness between 3 nm and 250 nm and is made of a first material that is transparent to the luminous spectrum in the visible range between 380 nm and 780 nm. The first material has a refractive index n less than or equal to 2 over the entire the visible range. The second interference layer (3) has a thickness between 3 nm and 80 nm and is made of a second material having a refractive index n and an absorption coefficient k respectively reaching a value greater than or equal to 3 and greater than or equal to 0.5, over at least part of the visible range.

### CROSS-REFERENCE TO RELATED APPLICATIONS

This application claims priority to European Patent Application No. 24221464.1, filed on Dec. 19, 2024, the entire contents of which are incorporated herein by reference.

### TECHNICAL FIELD OF THE INVENTION

The invention relates to a horology component coloured by interference effect, and in particular a balance spring coloured by interference effect.

### TECHNOLOGICAL BACKGROUND

Conventionally, certain metal alloy balance springs used in horology underwent a bluing treatment to enhance their appearance and corrosion resistance. With the advent of silicon balance springs comprising an outer layer of silicon oxide, which gives them the appropriate mechanical properties to compensate the temperature of the running of a watch, the use of blue balance springs has declined. Indeed, the functionality of the balance spring component has been given priority over its aesthetics. When they were first developed, these balance springs comprised a single layer of silicon oxide, known as a temperature compensation layer, with a thickness range greater than one micron, giving the balance springs a greyish tinge. Later, to counteract both the electrostatic effects and the influence of humidity, the balance springs were plated with a metallic layer, giving them a metallic appearance.

US document 2022/0004149 discloses a black photovoltaic device. Conventional thin-film amorphous silicon solar cells have a reddish colour similar to that of aubergines, because they reflect light with wavelengths greater than around 650 nm. This colour is often considered unattractive and therefore undesirable in the horology field, particularly for dials. To remedy this problem, this document provides a photovoltaic device comprising an electrically conductive front contact layer; an electrically conductive rear contact layer, the rear contact layer being intended to be located further from an incident light source than the front contact layer; and a semiconductor-based PIN junction comprising a layer of substantially amorphous intrinsic silicon sandwiched between a p-type doped semiconductor layer and an n-type doped semiconductor layer. According to the invention, the layer of the PIN junction located closest to the rear contact layer is a silicon-germanium alloy layer comprising at least 2 mol % germanium. The silicon-germanium alloy enables visible light to be absorbed in the red wavelength range, that is, in the wavelength ranges normally transmitted by amorphous silicon-based devices. This results in a photovoltaic device with a deep black colour, compensating for the red, aubergine or violet colour typical of amorphous silicon photovoltaic devices.

To colour the visible face of the balance spring, an interference colouring method was proposed in EP 3 608 728. The method consists in adjusting the thickness of the silicon oxide layer on the visible face to a value of less than 1 μm so as to obtain different colours depending on the thickness of the layer. To ensure the thermal compensation required for an SiO₂ layer thickness greater than 1 μm, only the visible face is coloured. This method is relatively complex to use to vary the thickness of the SiO₂ layer depending on the face and has the drawback that not all faces can be coloured. Another drawback is that the observed colour varies depending on the angle of observation.

### SUMMARY OF THE INVENTION

The present invention aims to provide another colouring method that is easy to use and enables all faces of the balance spring to be coloured without any noticeable influence by the angle of observation.

To this end, it is proposed to deposit two interference layers with different optical properties on all or at least the desired faces of the balance spring and, in general, of the horology component.

More specifically, the present invention relates to a horology component comprising a substrate, a first interference layer in direct or indirect contact with the substrate and a second interference layer covering the first interference layer, with said second interference layer intended to be oriented toward an incident light source, said first interference layer being characterised in that it has a thickness comprised between 3 nm and 250 nm and in that it is made of a first material that is transparent to the luminous spectrum in the visible range between 380 nm and 780 nm, with said first material having a refractive index n less than or equal to 2 over the entire said visible range, said second interference layer being characterised in that it has a thickness comprised between 3 nm and 80 nm and in that it is made of a second material having a refractive index n and an absorption coefficient k respectively reaching a value greater than or equal to 3 and greater than or equal to 0.5, over at least part of said visible range.

The addition of this second absorbing interference layer with a high refractive index to a first interference layer with a low refractive index makes it possible to obtain vivid colours while keeping the optical system relatively simple. Moreover, the second absorbing layer remains an interference layer while offering useful properties, in particular a reflection spectrum that varies little depending on the angle of observation. Then, depending on the thickness of each of the interference layers, a wide variety of colours can be obtained.

Typically for a balance spring, the first interference layer is an SiO₂ layer and the second interference layer is an amorphous Si layer. Another advantage of the second amorphous Si layer is that it does not absorb water. It could therefore act as a barrier to humidity.

This second layer can also be doped with boron or phosphorus, for example, to produce a slightly conductive layer, of the p or n type, respectively, this property being useful for keeping the surface from becoming charged.

### BRIEF DESCRIPTION OF THE FIGURES

FIG. 1 is a perspective view of a balance spring according to the invention.

FIG. 2 is a cross-section of a coil on the balance spring shown in FIG. 1.

FIG. 3 schematically shows the optical path of the incident light through the interference layers.

FIG. 4 shows the variation in the refractive index n and in the absorption coefficient k of amorphous silicon depending on the wavelength.

### DETAILED DESCRIPTION OF THE INVENTION

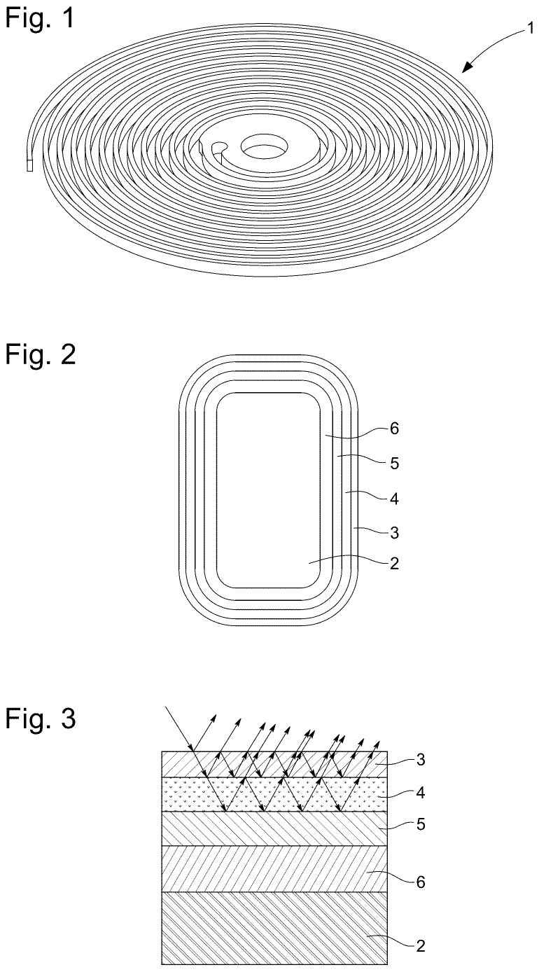

The invention relates to a horology component coloured by interference effect. The horology component can be a horology component for the external part, such as a dial, or for the movement. For example, a movement component can be a balance spring, an escapement wheel or a pallet. The invention is more specifically described hereinafter for a balance spring 1 as shown in FIG. 1.

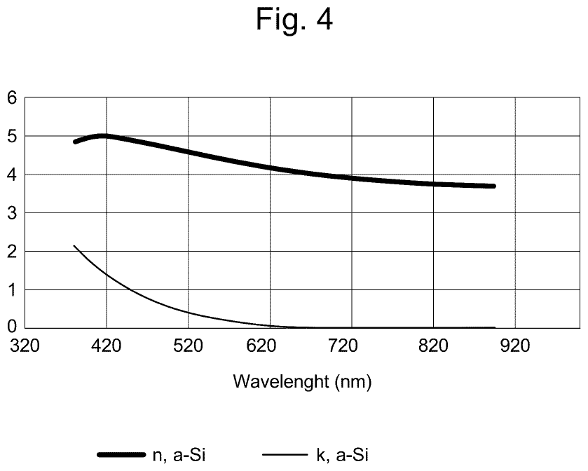

The horology component comprises a substrate 2 covered in whole or in part by two interference layers 4 and 3. A first interference layer 4 is in direct or indirect contact with the substrate 2. A second interference layer 3 covers the first layer 4 and is intended to receive incident light. The second layer 3 is made from a material with a high refractive index n and a high absorption coefficient k in the visible range between 380 nm and 780 nm. This layer 3 has a thickness comprised between 3 nm and 80 nm depending on the desired interference colour. The materials chosen for this layer generally have an index n and a coefficient k in the visible range that are variable depending on the wavelength. By way of example, FIG. 4 shows the variation in the refractive index n and in the absorption coefficient k of amorphous silicon depending on the wavelength. According to the invention, the criteria of high index n and high coefficient k must be met over at least part of the visible range between 380 nm and 780 nm and not necessarily over the entire range. “High refractive index n” is taken to mean an index n with a value greater than or equal to 3, or even greater than or equal to 4, over at least part of the 380 nm-780 nm range. In the example shown in FIG. 4, it can be seen that the index n is greater than 4 for the 380 nm-720 nm range and greater than 3 over the entire 380 nm-780 nm range. “High absorption coefficient k” is taken to mean a coefficient k with a value greater than or equal to 0.5, or even greater than or equal to 1, over at least part of the 380 nm-780 nm range. In the example shown in FIG. 4, it can be seen that the coefficient k is greater than 0.5 below 500 nm and greater than 1 for a wavelength below 440 nm.

The second interference layer 3 can, for example, be a layer of amorphous silicon or amorphous germanium or one of their alloys, with the silicon or germanium being possibly alloyed with carbon or hydrogen by way of example. According to the invention, the second interference layer can be doped with boron or phosphorus to produce a slightly conductive p-type or n-type layer, respectively. Preferentially, the concentration of P- or N-type dopants is greater than or equal to 10¹⁷ atoms per cm³. Advantageously, the doped layer is deposited by plasma-enhanced chemical vapour deposition (PECVD).

The material with a high n index and a high k coefficient is deposited in direct contact with another material with a lower n index to promote reflection at the interface between the two materials. This is the first interference layer 4, which typically has a thickness comprised between 3 nm and 250 nm, depending on the desired colour in combination with the second layer. The material of this first layer 4 has a refractive index n with a maximum value of 2, or even of 1.5 in the 380 nm-780 nm range. Here again, the refractive index n can vary within this range. “Maximum value of 2, or even of 1.5” is taken to mean that the index does not exceed this value over the entire 380 nm-780 nm range. This first layer 4 also has the characteristic of being transparent in the visible range between 380 nm and 780 nm. The first interference layer 4 can, for example, be an oxide layer, such as a layer of silicon oxides, of zinc oxides, of tin oxides or of titanium oxides, or a nitride layer, such as a layer of silicon nitrides.

The first and second layers can be deposited by plasma enhanced chemical vapour deposition (PECVD), atomic layer deposition (ALD), physical vapour deposition (PVD), etc.

The first layer 4 is in direct or indirect contact with the substrate 2, which can be made of any type of material: metal, ceramic (carbides, nitrides, oxides), etc. If the contact is indirect, one or more intermediate layers 5,6 are deposited between the substrate 2 and the first layer 4 (FIGS. 2 and 3). Preferentially, the refractive index of the substrate in direct contact with the first layer or of the intermediate layer in direct contact with the first layer is different from the refractive index of the first layer. The refractive index of the substrate in direct contact with the first layer or of the intermediate layer in direct contact with the first layer is therefore preferably greater than 2. More preferentially, it is greater than or equal to 2.5.

For the balance spring 1 shown in FIGS. 1 to 3, the substrate 2 is made of crystalline silicon. It is covered by a first intermediate layer 6 made of thermally compensating SiO₂ with a thickness greater than one micron, then by a metallic layer 5, for example made of chromium, titanium, tantalum or one of their alloys, with a thickness comprised between 5 and 50 nm in order to dissipate the charges and prevent the absorption of water. This metallic layer 5 is then covered by the two interference layers 4 and 3 with the first layer 4 made of SiO₂ and the second layer 3 made of amorphous Si.

For an external part such as a dial, the latter comprises a crystalline silicon substrate successively plated with the first SiO₂ interference layer and the second amorphous Si interference layer. According to one variant, this is a dial comprising a solar cell with a substrate consisting of crystalline Si successively plated with the first interference layer made of silicon oxide or silicon nitride (SiO₂ or Si₃N₄) and with the second interference layer made of amorphous Si.

FIG. 3 diagrams the optical paths of the incident light reflected at the interface between the first interference layer 4 and the second interference layer 3 and between the second intermediate layer 5 and the first interference layer 4, with the transmission effects within the two interference layers 3,4 enabling a variable interference colour to be obtained depending on their thickness. For example, bright blue colours are obtained with a first layer thickness of 60 nm and a second layer thickness of 5 nm. Colours with more violet hues are obtained by reducing the thickness of the first layer 4 to 30-50 nm. Colours that are more pastel are obtained by increasing the thickness of the two layers.

1. A horology component comprising a substrate, a first interference layer in direct or indirect contact with the substrate and a second interference layer covering the first interference layer, with said second interference layer oriented toward an incident light source, said first interference layer having a thickness comprised between 3 nm and 250 nm and in being made of a first material that is transparent to the luminous spectrum in the visible range between 380 nm and 780 nm, with said first material having a refractive index n less than or equal to 2 over the entire said visible range, said second interference layer having a thickness comprised between 3 nm and 80 nm and being made of a second material having a refractive index n and an absorption coefficient k respectively reaching a value greater than or equal to 3 and greater than or equal to 0.5, over at least part of said visible range.

2. The horology component according to claim 1, wherein the refractive index n and the absorption coefficient k of the second interference layer respectively reach a value greater than or equal to 4 and greater than or equal to 1, over at least part of said visible range.

3. The horology component according to claim 1, wherein the first interference layer has a refractive index n less than or equal to 1.5 over the entire visible range.

4. The horology component according to claim 3, wherein the first interference layer is a layer of an oxide or of a nitride.

5. The horology component according to claim 4, wherein the first interference layer is a layer of SiO₂ or Si₃N₄.

6. The horology component according to claim 1, wherein the second interference layer is a layer of amorphous Si, of amorphous Ge or of one of their alloys.

7. The horology component according to claim 1, wherein one or more intermediate layers are deposited between the substrate and the first interference layer.

8. The horology component according to claim 1, wherein the substrate in direct contact with the first interference layer or the intermediate layer in direct contact with the first interference layer are made of a third material with a refractive index n greater than 2 over the entire visible range.

9. The horology component according to claim 1, wherein the second interference layer has a concentration of P-type or N-type dopants.

10. The horology component according to claim 1, wherein the concentration of P-type or N-type dopants is greater than or equal to 10¹⁷ atoms per cm³.

11. The horology component according to claim 7, wherein said horology component is a balance spring with a crystalline Si substrate (2) plated successively with a first SiO₂ intermediate layer, a second metallic intermediate layer, a first SiO₂ interference layer and a second amorphous Si interference layer.

12. The horology component according to claim 1, wherein said horology component is a dial with a crystalline Si substrate plated successively with a first SiO₂ interference layer and a second amorphous Si interference layer.

13. The horology component according to claim 1, wherein said horology component is a dial composed of a solar cell comprising a crystalline Si substrate plated successively with a first SiO₂ or Si₃N₄ interference layer and a second amorphous Si interference layer.
